(19) United States
(12) Patent Application Publication
(10) Pub. No.: US 2016/0271616 A1
(43) Pub. Date: Sep. 22, 2016

(54) Grinding Device Having A Wear Disk

(71) Applicant: NETZSCH-Feinmahltechnik GmbH, Selb (DE)

(72) Inventors: Udo Enderle, Arzberg (DE); Holger Moeschl, Selb (DE); Lars-Peter Weiland, Schonwald (DE); Andreas Sawerwald, Marktredwitz (DE)

(21) Appl. No.: 15/169,038

(22) Filed: May 31, 2016

Related U.S. Application Data
(63) Continuation of application No. PCT/DE2014/000614, filed on Dec. 3, 2014.

(30) Foreign Application Priority Data
Dec. 13, 2013 (DE) 102013114001.7

(51) Int. Cl. B02C 17/18

(52) U.S. Cl. CPC B02C 17/181; B02C 17/1825; B02C 2210/02

(57) ABSTRACT

A grinding device, including: a closed grinding chamber for accommodating a material to be ground and for accommodating a plurality of grinding bodies that can be moved together with the material; a stirring unit accommodated in the grinding chamber, which stirring unit is rotatably operatively connected to a drive unit arranged outside of the grinding chamber; a bearing unit, which guides the shaft and is arranged in the region of an opening of the grinding chamber; and at least one wear disk, which keeps the bearing unit covered at least in some regions with respect to the material to be ground and which lies against a counter surface associated with the bearing unit.

### TECHNICAL FIELD

The present invention concerns a grinding device with a grinding volume for purposes of accommodating a material that is being reduced in scale, together with a plurality of grinding bodies that can move with the material.

### BACKGROUND

Such grinding devices are already of known art from the prior art, and serve to provide the coarse, fine and finest reduction in scale, or the homogenisation of material that is being ground. They consist of a grinding volume that is set into rotation, in which the material that is being ground is reduced in scale by grinding bodies. As a general rule the grinding volume is formed by an approximately circular cylindrical grinding container mounted such that it can rotate horizontally. The grinding mills are filled through a central opening in one of the end faces. The output is dependent on the construction and takes place, for example, through slots in the grinding volume wall at the end of the grinding mill, wherein the grinding bodies are held back by a separating device.

A special form of such a grinding device is the agitator bead mill. Agitator bead mills consist of a vertically or horizontally arranged grinding container, usually approximately cylindrical, which is filled with grinding bodies to 70-90%. In the case of agitator bead mills the grinding container as a general rule is mounted so as to be stationary, not rotating. An agitator with suitable agitating elements provides for intensive movement of the grinding bodies together with the material that is being ground. The grinding bodies consist, for example, of steel or wear-resistant ceramic materials. The suspension of the material that is being ground is continuously pumped through the grinding volume. Here the suspended solids are reduced in scale, that is to say, dispersed, by impact and shear forces between the grinding bodies. At the output of the grinding mill, the separation of the material that is being ground from the grinding bodies takes place by means of a suitable separating device.

The grinding bodies that are used lead to wear of the grinding container. In the case of bead mills, or agitator bead mills, the risk exists that the container inner wall may be damaged by the grinding beads. In particular, in the case of bead mills, or agitator bead mills, with a horizontally aligned grinding container, the additional risk exists that the cover flange can be damaged by the grinding bodies. For this reason there are wear protection elements of known art, which preferably can easily be replaced and serve to protect the respective components of the bead mills, or agitator bead mills. The wear protection elements must be regularly replaced.

The document DE 10 2011 051 041 A1 describes an agitator bead mill with a vertically arranged grinding container and wear protection. The latter is attached to the container inner wall by means of an attachment system. The attachment system consists of an attachment pin and an attachment recess. For purposes of releasing the wear protection element the latter must be removed from the container inner wall.

If the wear protection element is to be replaced after a certain period of time then attachments arranged in the grinding volume must be released. Since the grinding volume, where appropriate, is closed by means of a cover, the cover must be removed before the replacement, which in practice is associated with an undesirable expenditure of time. Also in the case of the device of the DE patent application the possibility that attachments for the wear element arranged in the interior of the grinding container may be damaged cannot be ruled out with any certainty, the result of which can sometimes be an unintended release of the respective wear element during a grinding process.

### SUMMARY

The object of the invention is therefore to make available a grinding device that is accompanied by the possibility of an uncomplicated replacement of wear disks. Furthermore, it should be possible to rule out any damage to any fixing provided for the wear disk during a grinding operation.

The above object is achieved by means of a grinding device that has the features in the independent claim. Further advantageous forms of embodiment are described by the dependent claims.

The invention concerns a grinding device, which in preferred forms of embodiment can be designed as a bead mill, or more specifically, as an agitator bead mill.

The grinding device comprises a closed grinding volume, that is to say, a closed grinding container, which is designed for purposes of accommodating a material that is being reduced in scale, together with a plurality of grinding bodies that can move with the material. With regard to its shape, the grinding volume, that is to say, the grinding container, can be designed as a hollow cylinder.

Furthermore, an agitator is provided, which is accommodated in the grinding volume, and which via a shaft is brought into a rotary operative connection with a drive unit, or more specifically, a motor, arranged outside the grinding volume. The agitator can have one or a plurality of arms extending from the axis of rotation of the agitator so as to move the respective material that is being ground together with the grinding bodies. The shaft and the agitator are preferably aligned flush with one another, oriented in the longitudinal direction of the shaft.

A bearing unit is also provided, which guides the shaft and is arranged in the region of an opening of the grinding volume, that is to say, the grinding container. The bearing unit can seal the grinding volume, that is to say, the grinding container in the region of the opening. In particular the grinding volume, that is to say, the grinding container, can be connected with a cover, which has an opening for the shaft. Moreover, the bearing unit can be accommodated in the opening, such that the cover together with the bearing unit and the shaft seals the grinding volume, that is to say, the grinding container. The opening can thus be formed through a cover of the grinding container.

Also conceivable is the provision of one or a plurality of fixing agents, such as screwed connections, which connect the grinding container, that is to say, the grinding volume, with the cover in a detachable manner. The grinding volume, that is to say, the grinding container, can thus be removed after the release of the fixing agents from the cover, where appropriate, or from the grinding device. The grinding container can also have a base, which seals the grinding volume. The base can also be connected with the grinding container in a detachable manner.

Furthermore the inventive grinding device comprises at least one wear disk, which protects the bearing unit, at least in some regions, from exposure to the material that is being ground; the said wear disk fits against a mating surface assigned to the bearing unit. A flat surface of the wear disk facing towards the mating surface can preferably be brought into full contact with the mating surface.

Since the wear disk protects the bearing unit, at least in some regions, from exposure to the material that is being ground, the material that is being ground cannot come into contact with the region of the bearing unit that is protected from exposure by means of the wear disk. Also the grinding bodies accommodated in the grinding volume, that is to say, in the grinding container, thus cannot come into contact with the region that is protected from exposure. Any damage to the bearing unit is avoided, at least for this region.

With regard to the configuration of the wear disk, numerous materials come into consideration. In preferred forms of embodiment, for example, the wear disk can be designed in ceramic.

The present invention is characterised in that the grinding device comprises at least two clamping agents arranged along the periphery of the wear disk, and, at least in some regions, outside the grinding volume, that is to say, the grinding container; the clamping agents grip the wear disk and are fixed on the mating surface with the application of force.

In order to fix the wear disk in position on the mating surface, provision can, for example, be made for the wear disk firstly to be fitted against the mating surface, and subsequently for the at least two clamping agents to be fixed on the grinding device, whereby, as a result the at least two clamping agents grip the wear disk and fix it in position on the mating surface. By release of the fixing provided for the clamping agents, a removal of the wear disk from the mating surface, that is to say, from the grinding device, can be accompanied by subsequent replacement. The fixings for the respective clamping agents can also sensibly be arranged outside the grinding volume, that is to say, outside the grinding container.

In various forms of embodiment provision can be made for the at least two clamping agents to encompass the wear disk completely.

In preferred forms of embodiment the design of the wear disk can feature at least one groove for the at least two clamping agents, into which groove the at least two clamping agents correspondingly fit for purposes of gripping the wear disk. Thus in various forms of embodiment of the present invention, the design of the wear disk can feature a particularly assigned groove for each of the at least two clamping agents, into which particularly assigned groove the respective member of the at least two clamping agents correspondingly fits in each case.

In further forms of embodiment it is conceivable that the design of the wear disk can feature a common groove for the at least two clamping agents, into which common groove the at least two clamping agents correspondingly fit for purposes of gripping the wear disk. In particular, forms of embodiment have proved themselves in which the at least one groove, at least in some sections, has a linear orientation. Thus the groove can, for example, be milled into the wear disk, that is to say, it can be introduced into the wear disk by means of material removal.

Moreover, it is conceivable that the design of the wear disk in the outer periphery features at least one flat surface for the at least two clamping agents; in particular this is introduced into the wear disk by means of material removal; the said at least one flat surface is fully gripped by the at least two clamping agents.

Here the design of the wear disk can feature a particularly assigned flat surface for each of the clamping agents, wherein the respective clamping agent encompasses the respective particularly assigned flat surface. In other forms of embodiment it is conceivable that the at least one flat surface introduced into the wear disk is guided radially over the periphery of the wear disk, and is gripped by all of the at least two clamping agents. In practice, particular forms of embodiment have proved themselves in which the at least one flat surface, at least in some sections, has a linear orientation.

Moreover, it can be that the at least two clamping agents arranged along the periphery of the wear disk fit against the mating surface and are detachably fixed in position on the mating surface by means of one or a plurality of fixing agents. The mating surface can sensibly have holes for this purpose, through which, for example, screwed connections grip and fix the at least two clamping agents in position. The holes can be oriented parallel to the shaft. In order to be able to hold the at least two clamping agents securely, that is to say, to be able to fix them in position, two holes, that is to say, at least two fixing agents, can be assigned to each clamping agent.

As stated above, in preferred forms of embodiment provision can be made for the design of the wear disk to feature a particularly assigned groove for each of the clamping agents, into which groove the respective clamping agent correspondingly fits for purposes of gripping the wear disk. For example, three clamping agents, together with three grooves can be available, wherein each clamping agent fits into each groove in a gripping manner.

Furthermore, provision can be made for the design of the wear disk to feature at least one sealing agent, the outer periphery of which is guided radially about a longitudinal axis of the wear disk. The at least one sealing agent can thus be designed as an O-ring. It can also be that another sealing agent, or more specifically, another O-ring, is arranged between the mating surface and a flanged section of the bearing unit.

In particular, forms of embodiment have proved themselves in which the respective cross-sectional area of the at least two clamping agents engaging with or encompassing the wear disk for purposes of a form fit increases, at least in some sections, in the direction of the grinding volume. For this purpose the design of the at least two clamping agents can feature an L-shape. The design of the clamping agents can therefore feature a first section and a second section, whereby the first section and the second section are oriented at right angles, that is to say, are perpendicular to one another. Other shapes are also conceivable in which, for example, each of the at least two clamping agents is designed in a conical manner. In preferred forms of embodiment each of the at least two clamping agents sensibly has a one-piece design.

In order to be able to guide the shaft, forms of embodiment have particularly proved themselves in which the bearing unit also seals the grinding volume, that is to say, the grinding container, in order to prevent any cover-side exit of material that is being ground from the grinding volume, that is to say, from the grinding container. In preferred forms of embodiment the bearing unit can therefore have a mechanical seal, that is to say, it can embody a mechanical seal.

Since, as already stated, it is sensible for a cover to be available for the grinding volume, that is to say, the grinding container, in practice forms of embodiment are desirable, in which the cover can also be protected from damage during a grinding process. For this purpose provision can be made for the grinding device, in addition to the already described first wear disk, which is fixed in position on the mating surface with the application of force by means of the at least two clamping agents, to comprise at least one second wear disk. Compared with the at least one first wear disk, the at least one second wear disk can have a larger diameter, and can sit on the at least one first wear disk. Furthermore, the at least one second wear disk can protect a cover of the grinding volume, that is to say, the grinding container, at least in some regions, and preferably completely, from exposure to the material that is being ground.

The at least one second wear disk can thus possess an opening for purposes of accommodating the at least one first wear disk. The at least one first wear disk can be accommodated with a form fit in the opening of the at least second one wear disk.

Furthermore, the at least one second wear disk can be fitted against the surface of the cover, and can be held on the cover in a clamped manner. For example, screwed connections can be available in order to fix the wear disk onto the cover. In particular, screwed connections can be available, each of which fixes the grinding volume, that is to say, the grinding container, and the at least one second wear disk, onto the cover. The at least one second wear disk can be arranged between the cover and the grinding volume, that is to say, the grinding container.

In practice, forms of embodiment have moreover proved themselves in which the at least one wear disk, or more specifically, the at least one first wear disk, possesses a conical shape. The cross-sectional area of the at least one wear disk can thus reduce continuously as it approaches the bearing unit. Furthermore, forms of embodiment are possible in which the flat surface of the wear disk facing in the direction of the grinding volume is oriented at right angles to the shaft.

### BRIEF DESCRIPTION OF THE DRAWINGS

In what follows examples of embodiment will elucidate in more detail the invention and its advantages with the aid of the accompanying figures. The proportions of the individual elements relative to one another in the figures do not always correspond to the real proportions, since some forms are shown in a simplified manner, and other forms are enlarged relative to other elements for purposes of better illustration.

FIG. 1 shows a cross-section through a form of embodiment of an inventive grinding device;

FIG. 2 shows a perspective view of a bearing unit, together with a wear disk of the form of embodiment from FIG. 1

FIGS. 3A and 3B show two cross-sections through a wear disk, as they can exist in various forms of embodiment of an inventive grinding device.

### DETAILED DESCRIPTION

Identical reference symbols are used for elements of the invention that are the same, or operate in the same manner. Furthermore, in the interests of clarity only those reference symbols are shown in the individual figures that are necessary for the description of the figure in question. The forms of embodiment shown represent just examples of how the inventive device can be configured, and do not represent any final limitation.

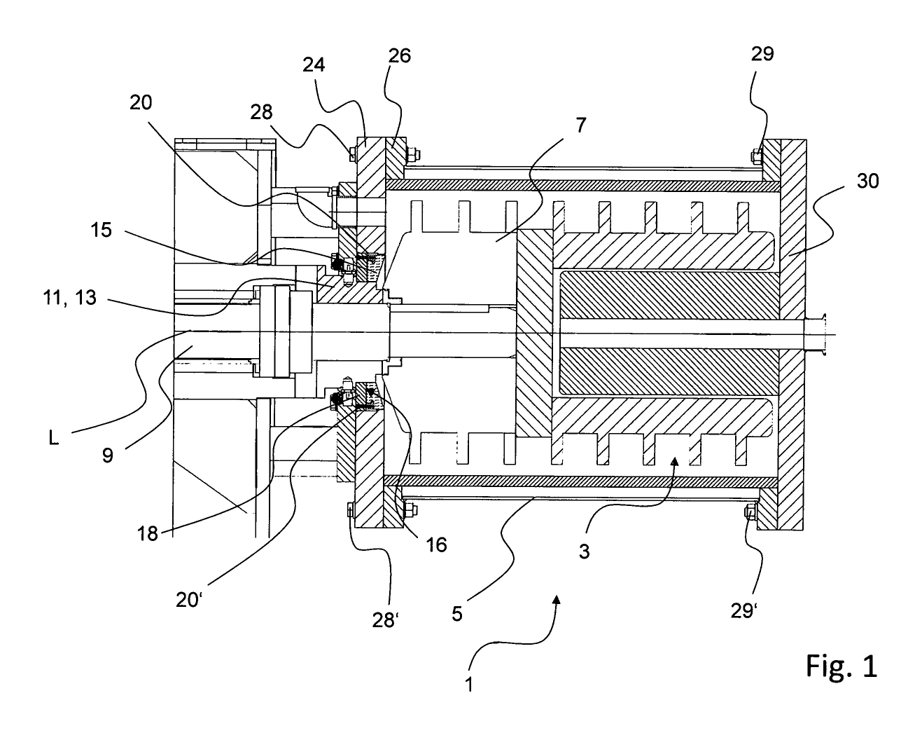

FIG. 1 shows a cross-section through a form of embodiment of an inventive grinding device 1. The grinding device 1 comprises a closed grinding volume 3, which is defined by a grinding container 5.

The grinding volume 3, that is to say, the grinding container 5, is provided for purposes of accommodating a material that is being reduced in scale, together with a plurality of grinding bodies (not represented) that can move with the material.

Also discernible is an agitator 7, which is accommodated in the grinding volume 3, that is to say, in the grinding container 5, and is driven by a shaft 9 such that it rotates about the axis L. Since the grinding container 5 is designed to be stationary, the shaft 9 rotates relative to the grinding container 5. Here the shaft 9 is connected with a drive unit, or more specifically, a motor, that is not represented in FIG. 1.

The bearing unit 11, which has a mechanical seal 13, guides the drive shaft 9, wherein the drive shaft 9 passes through the bearing unit 11, or more specifically, through the mechanical seal 13, and enters the grinding volume 3, that is to say, the grinding container 5.

Since some sections of the bearing unit 11, or more specifically, of the mechanical seal 13, also enter into the grinding volume 3, damage could occur to the bearing unit 11 as a result of a grinding operation of the device 1 by virtue of contact of material that is being ground with the bearing unit 11. In order to avoid damage to the bearing unit as a result of contact with material that is being ground, or to reduce the risk of damage to the bearing unit as a result of contact with material that is being ground, a wear disk 15 is provided, which protects regions of the bearing unit 11 from exposure to the material that is being ground, and which fits against a mating surface 16 assigned to the bearing unit 11. The mating surface 16 is a component of a flanged section 18 of the bearing unit 11, and is brought into contact with a flat surface of the wear disk 15.

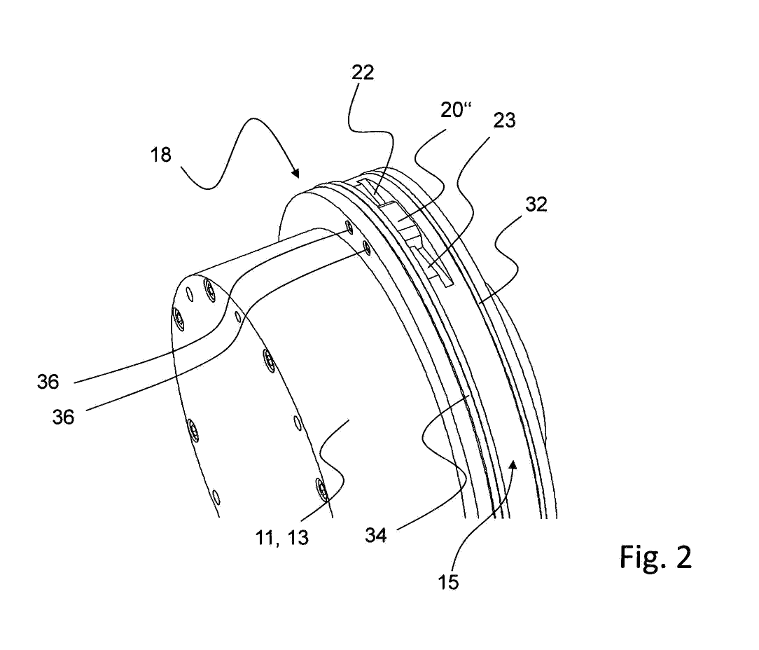

The grinding device 1 furthermore comprises three clamping agents arranged along the periphery of the wear disk 15; two of these clamping agents 20 and 20′ can be discerned in the cross-section of FIG. 1. A third clamping agent 20″ is represented in FIG. 2. The clamping agents 20 and 20′ that can be discerned in FIG. 1 are arranged outside the grinding volume 3, that is to say, outside the grinding container 5; they are designed as claws, grip the wear disk 15, and with the application of force fix the latter in position on the mating surface 16 of the flanged section 18. Here each of the clamping agents 20, 20′ and 20″ fits into a groove 22 of the wear disk 15, as can very easily be discerned in the following FIG. 2.

In the example of embodiment from FIG. 1 the wear disk 15 is designed with a conical shape. Thus the cross-sectional area of the wear disk 15 tapers in the direction of the bearing unit 11. It can also be discerned that the bearing unit 11, or more specifically, the mechanical seal 13, is accommodated with a form fit in an opening of the wear disk 15, and also with a form fit in an opening of the flanged section 18.

In various forms of embodiment of the present invention, the grinding device 1 also comprises a second wear disk, not represented in FIG. 1, which sits on the wear disk 15 and accommodates with a form fit the first wear disk 15 in an opening. By means of the second wear disk the cover 24 of the grinding volume 3, that is to say, of the grinding container 5, is protected from exposure to the material that is being ground. The risk of any damage to the cover 24 as a result of contact with the material that is being ground during a grinding process can be eliminated by means of the second wear disk, not represented in FIG. 1.

On its side facing towards the cover 24 the grinding container 5 possesses a flange 26, which has a plurality of holes for purposes of accommodating screwed connections 28 and 28′ respectively. In the cross-section of FIG. 1 two screwed connections 28 and 28′ can be discerned. The cover 24 also has holes, which are oriented such that they are aligned with the holes of the flange 26, and through which the screwed connections 28 and 28′ grip for purposes of fixing the grinding container 5 onto the cover 24. If a second wear disk is provided, as described above, the design of the second wear disk can also feature holes, through which the screwed connections 28 and 28′ grip. Here the second wear disk can be arranged between the cover 24 and the flange 26 in a clamped manner. Alternatively, the second wear disk can be separately attached to the cover 24, wherein in a preferred form of embodiment the means of attachment are located outside the grinding volume 3, and do not come into contact with the material that is being ground.

By releasing the screwed connections 28 and 28′ the grinding container 5 can be removed from the cover 24. On a side located opposite to the cover 24, a base 30 can be held on the grinding container 5 in a removable manner by means of further screwed connections 29 and 29′.

Since the clamping agents 20, 20′ and 20″, which grip onto the wear disk 15, are arranged outside the grinding container 5, they are not subject to any wear.

FIG. 2 shows a perspective view of a bearing unit 11, together with a wear disk 15 of the form of embodiment from FIG. 1.

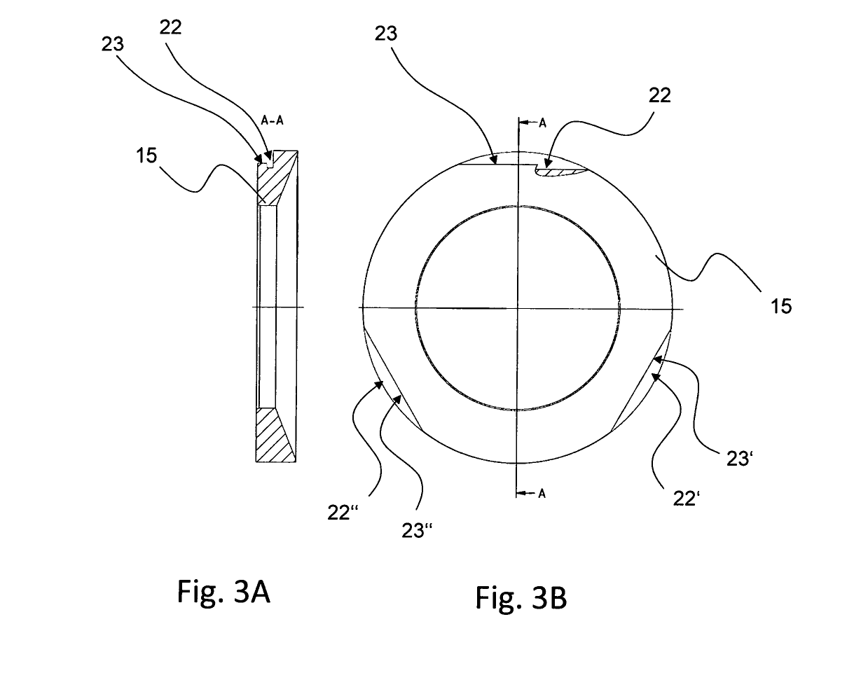

As can be discerned in FIG. 2 the wear disk 15 possesses a groove 22, with which the clamping agents 20, 20′ and 20″ engage. Three grooves 22, 22′ and 22″ are formed over the periphery of the wear disk 15, together with three flat surfaces 23, 23′ and 23″ associated with the grooves 22, 22′ and 22′ (cf. FIG. 3). The grooves 22, 22′ and 22 and also the flat surfaces 23. 23′ and 23″ are hereby introduced into the wear disk 15 by milling, such that the grooves 22, 22′ and 22, together with the flat surfaces 23, 23′ and 23″, do not follow the circular outer periphery of the wear disk 15, and possess a linear orientation. In each case a clamping agent 20, 20′, or 20″ engages in one of the grooves 22 and 22′ and 22″, and hereby encompasses the flat surface 23, 23′, or 23″ respectively associated with the respective groove 22, 22′, or 22″.

However, in other forms of embodiment it is also conceivable that the groove 22, 22′, or 22″ extends along the whole periphery of the wear disk 15 and that all clamping agents 20, 20′ and 20″ engage with a common groove (not represented). At least two flat surfaces 23 and 23′, or 23″ can hereby be designed as constituent parts of the wear disk 15; the said at least two flat surfaces 23, 23′, or 23″ are encompassed by the clamping agents 20, 20′, or 20″.

It is also conceivable that the flat surfaces 23, 23′ and 23″ are not formed, and that in a region that is encompassed by the clamping agents 20, 20′ and 20″ the wear disk 15 has a diameter over the whole periphery that is reduced relative to that of other regions. Here the groove 22, 22′, or 22″ can also extend as a common groove along the whole periphery of the wear disk 15, wherein each of the clamping agents 20, 20′ and 20″ engages with the common groove, and encompasses the wear disk 15 in the region of the reduced diameter.

In various other forms of embodiment it is also conceivable that the grooves 22, 22′ and 22″, as represented in an exemplary manner in FIG. 2, are introduced into regions of the wear disk 15 along the periphery of the wear disk 15. Here the flat surfaces 23, 23′ and 23″ cannot be formed, however, the wear disk 15—as described above—in a region that is encompassed by the clamping agents 20, 20′ and 20″, can have a diameter over the whole periphery that is reduced relative to that of other regions.

The dimensioning, or more specifically, the diameter of the wear disk 15 in the present examples of embodiment is to be understood as just exemplary. It is also conceivable that in one region, which is arranged between the clamping agents 20, 20′, and 20″ and the grinding volume 3, the wear disk 15 has a diameter that is increased compared with that of the flanged section 18, or more specifically, the mating surface 16. Furthermore, it can be that the clamping agents 20, 20′, or 20″ encompass the wear disk 15, and fix it in position on the mating surface 16 of the flanged section 18.

In order to prevent any exit of material that is being ground from the grinding volume 3, the wear disk 15 possesses an 0-ring 32.

As can be discerned in FIG. 2, the clamping agents 20, 20′ and 20″ stand on a mating surface 16 and do not project radially above the mating surface 16. The clamping agents 20, 20′ and 20″ are designed in one piece and are L-shaped, and thus possess two regions, which are oriented at right angles to one another. A further advantage of the preferred form of embodiment with flat surfaces 23, 23′, or 23″ consists in the accommodation of torque, thereby possible by means of a form fit, of the moment transferred onto the wear disk 15 by the material that is being ground and the grinding bodies.

In order to seal the grinding volume 3 the bearing unit 11, or more specifically, the mechanical seal 13, also possesses an O-ring 34. On the wear disk 15 stands, moreover, a second wear disk, not represented in FIG. 2, which accommodates the wear disk 15 in an opening, and protects the cover 24 (cf. FIG. 1) of the grinding container 5 from exposure to the material that is being ground.

The design of the flanged section 18 features holes 36 and 36′ oriented parallel to one another, which accommodate the screwed connections for purposes of fixing the clamping agents 20, 20′ and 20″. If a wear disk 15 is to be fixed in position on the flanged section 18, the wear disk 15 is firstly set in position on the mating surface 16, the clamping agents 20, 20′ and 20″ are then guided into the respective groove 22, and are fixed in position by means of the screwed connections accommodated in the holes 36, so that as a result the wear disk 15 is fixed in position on the mating surface 16 with the application of force.

FIGS. 3A and 3B show two cross-sectional representations through a wear disk 15, as they can exist in various forms of embodiment of an inventive grinding device 1. Here FIG. 3A shows the cross-section along the line A from FIG. 3B.

Thus in FIG. 3A a groove 22 can once more be discerned, together with the conical geometry of the wear disk 15. FIG. 3B shows once again the grooves 22, 22′ and 22″, together with the flat surfaces 23, 23′ and 23″, which are evenly distributed over the periphery of the wear disk 15, together with an opening of the wear disk 15, through which passes the bearing unit 11, or more specifically the mechanical seal 13.

The invention has been described with reference to a preferred form of embodiment. However, for a person skilled in the art, it is conceivable that variations or alterations can be made to the invention, without thereby leaving the scope of protection of the following claims.

1. A grinding device, comprising
a closed grinding volume for purposes of accommodating a material that is being reduced in scale, together with a plurality of grinding bodies that can move with the material.
an agitator accommodated in the grinding volume, which agitator, via a shaft, is brought into a rotary operative connection with a drive unit arranged outside the grinding volume.
a bearing unit, which guides the shaft and is arranged in the region of an opening of the grinding volume, together with
at least one wear disk, which protects the bearing unit, at least in some regions, from exposure to the material that is being ground, and which wear disk fits against a mating surface assigned to the bearing unit, characterised in that
the grinding device comprises at least two clamping agents arranged along the periphery of the wear disk, and at least in some regions outside the grinding volume; the clamping agents grip the wear disk and fix it in position on the mating surface with the application of force and/or in a form fit.

2. The grinding device in accordance with claim 1, in which the at least two clamping agents arranged along the periphery of the wear disk fit against the mating surface, and are detachably fixed in position on the mating surface by means of one or a plurality of fixing agents.

3. The grinding device in accordance with claim 1, in which the design of the wear disk can feature at least one groove for the at least two clamping agents, into which groove the at least two clamping agents correspondingly fit for purposes of gripping the wear disk.

4. The grinding device in accordance with claim 3, in which the design of the wear disk can feature a particularly assigned groove for each of the at least two clamping agents; the respective member of the at least two clamping agents correspondingly fits into the respective particularly assigned groove.

5. The grinding device in accordance with claim 3, in which the design of the wear disk features a common groove for the at least two clamping agents, into which common groove the at least two clamping agents correspondingly fit for purposes of gripping the wear disk.

6. The grinding device in accordance with claim 3, in which the at least one groove, at least in some sections, has a linear orientation.

7. The grinding device in accordance with claim 1, in which the design of the wear disks in the outer periphery features at least one flat surface, in particular introduced into the wear disk by means of material removal, for the at least two clamping agents; the at least one flat surface is encompassed by the at least two clamping agents.

8. The grinding device in accordance with claim 7, in which the design of the wear disk can feature a particularly assigned flat surface for each of the clamping agents, wherein the respective clamping agent encompasses the respective particularly assigned flat surface.

9. The grinding device in accordance with claim 7, in which the at least one flat surface introduced into the wear disk is guided radially over the periphery of the wear disk, and is gripped by all of the at least two clamping agents.

10. The grinding device in accordance with claim 1, in which the at least one flat surface, at least in some sections, has a linear orientation.

11. The grinding device in accordance with claim 1, in which the design of the wear disk features at least one sealing agent, the outer periphery of which is guided radially about a longitudinal axis of the wear disk.

12. The grinding device in accordance with claim 1, in which the respective cross-sectional area of the at least two clamping agents increases, at least in some sections, in the direction of the grinding volume, engaging with or encompassing the wear disk for purposes of a form fit.

13. The grinding device in accordance with claim 1, comprising at least one first wear disk, which by means of the at least two clamping agents is fixed in position on the mating surface with the application of force, together with at least one second wear disk, which compared with the at least one first wear disk has a larger diameter, and which sits on the at least one first wear disk.

14. The grinding device in accordance with claim 13, in which the at least one second wear disk can protect a cover of the grinding volume, at least in some regions, from exposure to the material that is being ground.

15. The grinding device in accordance with claim 14, in which the at least one second wear disk is fitted against the surface of the cover, and is held on the cover in a clamped manner.

16. The grinding device in accordance with claim 1, in which the wear disk possesses a cone-shaped geometry.
